(19) United States
(12) Patent Application Publication
(10) Pub. No.: US 2015/0097519 A1
(43) Pub. Date: Apr. 9, 2015

(54) WIRELESS CHARGER WITH COIL POSITION ADJUSTABILITY

(71) Applicant: CyberPower Systems, Inc., Taipei City (TW)

(72) Inventor: Chih-Ming CHEN, Taipei City (TW)

(73) Assignee: CyberPower Systems, Inc., Taipei City (TW)

(21) Appl. No.: 14/048,211

(22) Filed: Oct. 8, 2013

(51) Int. Cl. H02J 7/02

(52) U.S. Cl. CPC H02J 7/025
USPC 320/108

(57) ABSTRACT

A wireless charger includes a base unit including a base member and a rack mounted at the base member for holding a mobile electronic device, a push-pull unit including a sliding seat mounted in the base member and slidable along a predetermined sliding path and automatically lockable to the base member at an adjusted position, and a power supply unit including a power-supplying coil mounted in the sliding seat and a circuit module mounted in the base member and electrically connected with the power-supplying coil for controlling the power-supplying coil to create an alternating electromagnetic field for enabling a power-receiving coil of a loaded mobile electronic device to take power from the electromagnetic field and to convert it back into electrical current for charging a battery in the mobile electronic device.

### BACKGROUND OF THE INVENTION

1. Field of the Invention

The present invention relates to wireless charging (inductive charging) technology, and more particularly to a wireless charger with coil position adjustability, which allows adjustment of the power-supplying coil to match with the configuration of a power-receiving coil in a mobile electronic device to be charged, achieving best charging performance.

2. Description of the Related Art

The rapid development of electronic and multimedia technologies has brought people remarkable convenience into people's lives. Nowadays, it is the market trend to create smart phone, tablet computer, digital camera, multimedia player and many other mobile electronic devices with light, thin, short and small characteristics.

For mobile application, an electronic device must overcome the problem of power supply consumption. A mobile electro device generally uses a rechargeable battery to provide the necessary working electric power. When the power of the rechargeable battery is low, a compatible battery charger is normally used to charge the rechargeable battery. Various battery chargers with different designs and specifications are commercially available for charging different models and kinds of mobile electronic devices. However, it is inconvenient to prepare and to carry battery chargers with different designs and specifications for different charging applications.

To solve the aforesaid problem, inductive charging (wireless charging) is created. Inductive charging (wireless charging) uses an electromagnetic field to transfer energy between a wireless charger and a mobile electronic device. An induction coil in the wireless charger is controlled to create an electromagnetic field, and an induction coil in the mobile electronic device takes power from the electromagnetic field and converts it back into electrical current to charge the battery of the mobile electronic device or run the mobile electronic device. These two induction coils in proximity combine to form an electrical transformer.

However, the position of an induction coil in any commercial wireless charger is predetermined and not adjustable. When a mobile electronic device is put in a wireless charger, the induction coil in the mobile electronic device must be kept in proximity to the induction coil in the wireless charger to achieve optimal inductive charging. However, commercial mobile electronic devices of different models, kinds or brands have their induction coils designed at different locations. When using a wireless charge to charge a mobile electronic device, the user must notice the loading position of the mobile electronic device in the wireless charger to make sure of perfect matching between the two induction coils. If a wireless charger provider creates a large series of wireless chargers having different coil configurations to meet different requirements for different charging applications, the wireless charger manufacturing cost will be greatly increased. An improvement is this regard is necessary.

### SUMMARY OF THE INVENTION

The present invention has been accomplished under the circumstances in view. It is therefore the main object of the present invention to provide a wireless charger with coil position adjustability, which allows adjustment of the position of the power-supplying coil conveniently and positively to achieve optimal wireless charging performance.

To achieve this and other objects of the present invention, a wireless charger with coil position adjustability comprises a base unit, a push-pull unit, and a power supply unit. The base unit comprises a base member, and a rack mounted at the base member for holding a mobile electronic device. The push-pull unit comprises a sliding seat mounted in the base member and slidable along a predetermined sliding path and automatically lockable to the base member at an adjusted position. The power supply unit comprises a power-supplying coil mounted in and movable with the sliding seat, and a circuit module mounted in the base member and electrically connected with the power-supplying coil for controlling the power-supplying coil to create an alternating electromagnetic field for wireless charging.

Further, the base member comprises an extension plate obliquely upwardly extended from a rear top side thereof, and two guide rails mounted at the extension plate and respectively in a parallel manner. Further, the push-pull unit comprises two sliding ways respectively located at two opposite lateral sides of the sliding seat and respectively slidably coupled to the guide rails of the base member, and an operating knob extended from the center of a back side of the sliding seat and suspending outside the base unit for operation by a user to move the sliding seat along the guide rails smoothly and stably.

### BRIEF DESCRIPTION OF THE DRAWINGS

FIG. 1 is an elevational view of a wireless charger in accordance with the present invention.

FIG. 2 is an exploded view of the wireless charger in accordance with the present invention.

FIG. 3 corresponds to FIG. 2 when viewed from another angle.

FIG. 4 is a sectional side view of the wireless charger in accordance with the present invention.

FIG. 5 is a rear side view of the present invention, illustrating the relationship between the push-pull unit and the power supply unit.

FIG. 6 corresponds to FIG. 5, illustrating adjustment of the position of the push-pull unit relative to the base member.

FIG. 7 corresponds to FIG. 6, illustrating the position of the push-pull unit relative to the base member after adjustment.

FIG. 8 corresponds to FIG. 4, illustrating the position of the push-pull unit adjusted relative to the base member.

FIG. 9 is a schematic drawing illustrating an application status of the present invention.

FIG. 10 is a schematic drawing illustrating another application status of the present invention.

### DETAILED DESCRIPTION OF THE PREFERRED EMBODIMENT

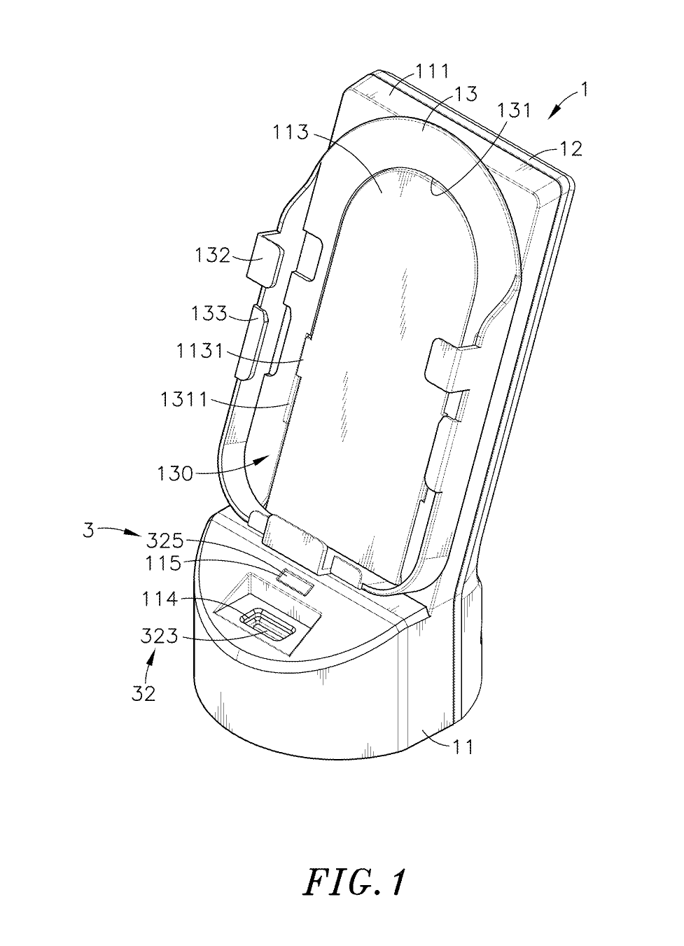

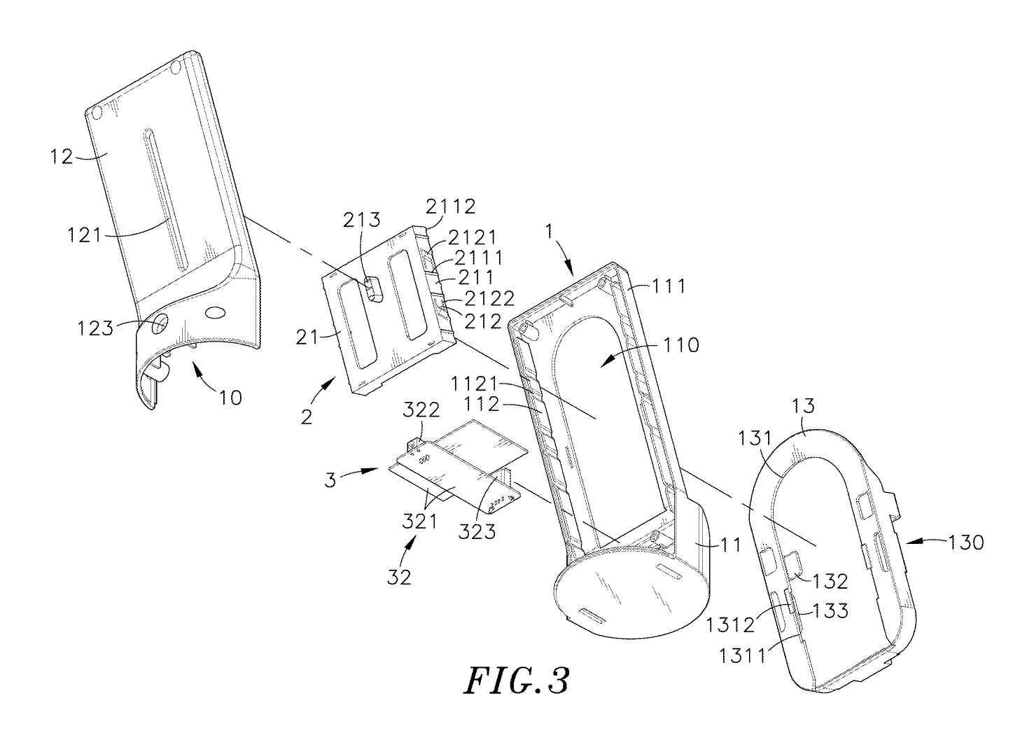

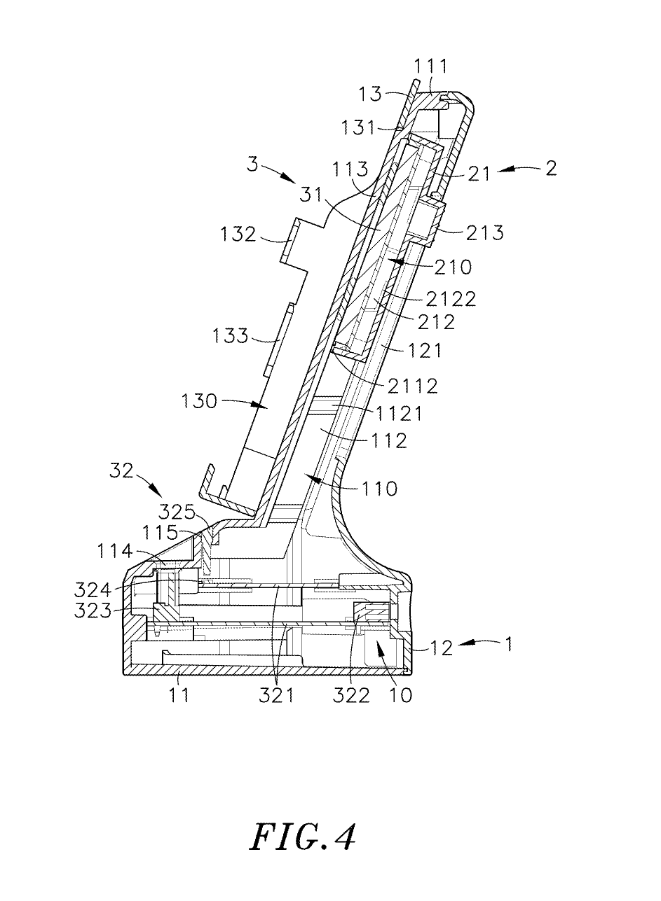

Referring to FIGS. 1-4, a wireless charger with coil position adjustability in accordance with the present invention is shown. The wireless charger comprises a base unit 1, a push-pull unit 2, and a power supply unit 3.

The base unit 1 comprises a base member 11, a back cover 12, and a rack 13. The base member 11 comprises an extension plate 111 obliquely upwardly extended from a rear top side thereof, a sliding space 110 defined in a back side of the extension plate 111, two guide rails 112 mounted at the back side of the extension plate 111 and respectively extended along two opposite lateral sides of the sliding space 110 in a parallel manner, and a plurality of position-limit grooves 1121 transversely formed in the guide rails 112 and spaced along the length of the guide rails 112.

The back cover 12 is fixedly fastened to the back side of the base member 11 by, for example, screws. Alternatively, hook joint, adhesive or laser welding may be employed to affix the back cover 12 to the base member 11. After the back cover 12 is affixed to the base member 11, an accommodation chamber 10 is defined between the base member 11 and the back cover 12 that accommodates the push-pull unit 2 and the power supply device 3. The back cover 12 comprises a longitudinal sliding slot 121 extending along the longitudinal center axis thereof, two longitudinal guide plates 122 located at an inside wall thereof and disposed in a parallel manner at two opposite lateral sides relative to the longitudinal sliding slot 121, and a plughole 123 disposed near a bottom side relative to the longitudinal sliding slot 121.

The base member 11 further comprises a raised platform 113 located at an opposing front side of the extension plate 111 for supporting the rack 13, two retaining lugs 1131 protruded from the front side of the extension plate 111 and respectively disposed at two opposite lateral sides of the raised platform 113 at selected locations, a first through hole 114 and a second through hole 115 located at the top wall thereof below the elevation of the extension plate 111 and at a front side relative to the extension plate 111.

The rack 13 defines a receiving space 130 in a front side thereof, comprising a positioning portion 131 for receiving the raised platform 113 of the base member 11, two insertion holes 1311 disposed at two opposite lateral sides relative to the positioning portion 131 for the insertion of the retaining lugs 1131, two retaining lugs 1132 respectively disposed adjacent to the insertion holes 1311 for engagement with the retaining lugs 1131 of the base member 11, and a plurality of hook lugs 132 and locating lugs 133 forwardly extended from the border area thereof for holding a mobile electronic device in the receiving space 130.

The push-pull unit 2 comprises a sliding seat 21 slidably mounted in the sliding space 110 in the back side of the extension plate 111 of the base member 11 of the base unit 1 and supported between the two longitudinal guide plates 122 of the back cover 12, a front mounting space 210 defined in a front side of the sliding seat 21, two sliding ways 211 respectively located at two opposite lateral sides of the sliding seat 21 and respectively slidably coupled to the guide rails 112 of the base member 11 of the base unit 1, a plurality of elastic clamping plates 212 respectively and symmetrically located at the two opposite lateral sides of the sliding seat 21 and spaced along the respective sliding ways 211 for engaging the position-limit grooves 1121 at the guide rails 112, each elastic clamping plate 212 having its one end formed integral with one end of one respective opening 2122 in the respective sliding way 211 and its other end terminating in a clamping portion 2121 for engaging one position-limit groove 1121 at one respective guide rail 112, a plurality of transverse ribs 2111 respectively located at the sliding ways 211 at opposing top and bottom sides relative to each elastic clamping plate 212 and respectively slidably stopped against the guide rails 112 of the base member 11, a plurality of raised portions 2112 respectively spaced along one side of each of the two sliding ways 211 and respectively slidably stopped against the extension plate 111 of the base member 11, and an operating knob 213 extended from the center of a back side of the sliding seat 21 and inserted through the longitudinal sliding slot 121 of the back cover 12 for operation by a user to move the sliding seat 21 along the longitudinal sliding slot 121.

The power supply unit 3 comprises a power-supplying coil 31 mounted in the front mounting space 210 of the sliding seat 21 of the push-pull unit 2, and a circuit module 32 mounted in the base member 11 electrically connected with the power-supplying coil 31. The circuit module 32 comprises at least one, for example, two circuit boards 321 mounted in the base member 11, a control circuit (not shown) installed in one circuit board 321, a first electrical connector 322 electrically mounted at a back side of one circuit board 321 and abutted against the plughole 123 of the back cover 12, a second electrical connector 323 electrically mounted at a front side of the same circuit board 321 opposite to the first electrical connector 322 and abutted against the first through hole 114 of the base member 11, a light-emitting device 324 electrically mounted at the other circuit board 321, and a prism light guide 325 adapted to guide emitted light from the light-emitting device 324 to the second through hole 115 of the base member 11.

Further, in this embodiment, the first electrical connector 322 of the circuit module 32 is an electrical power socket for receiving an electrical power plug (not shown) that is inserted into the plughole 123 of the back cover 12; the second electrical connector 323 is a female USB connector for receiving a male USB connector (not shown) that is inserted into the first through hole 114 of the of the base member 11. Further, the light-emitting device 324 can be a LED (light-emitting diode), a laser diode, or a lamp bulb. The circuit module 32 controls the induction coil 31 to create an alternating electromagnetic field so that an external induction coil in an external mobile electronic device (not shown) that is mounted in the rack 13 can take power from the electromagnetic field and converts it back into electrical current to charge the battery in the external mobile electronic device. The technologies regarding to how the circuit module 32 works and controls the power-supplying coil 31 to create an alternating electromagnetic field and how the circuit module 32 controls the light-emitting device 324 to give off light or to flash are of the known art, and no further detailed description will be necessary.

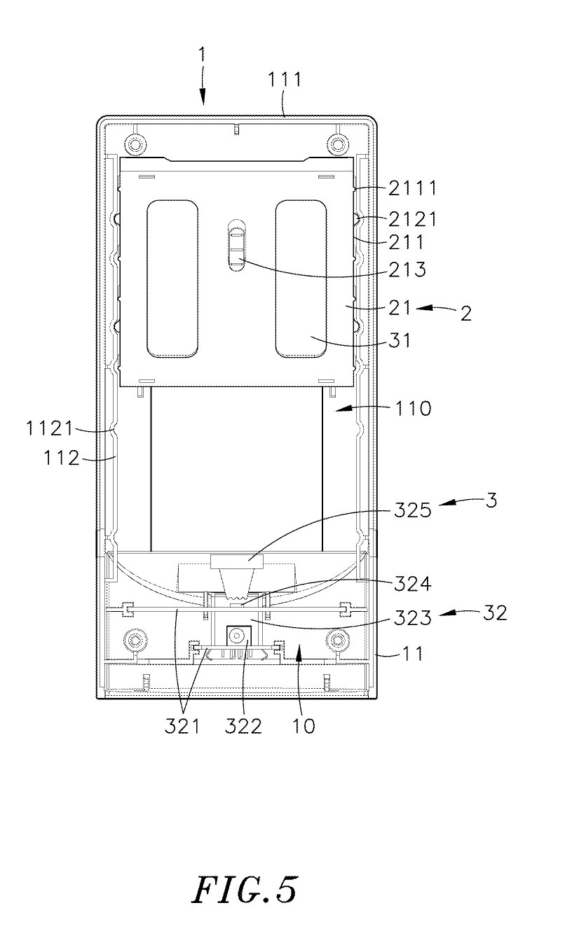

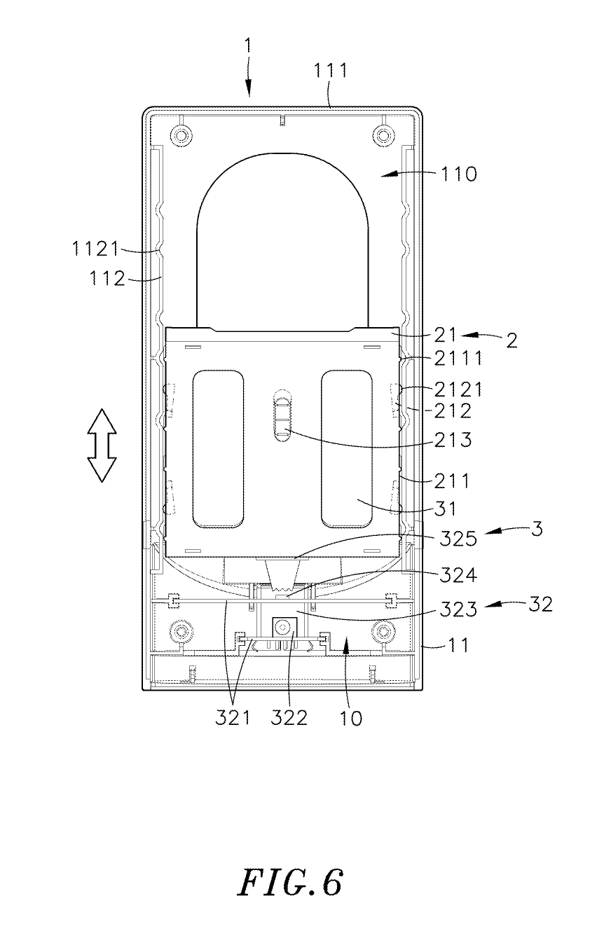

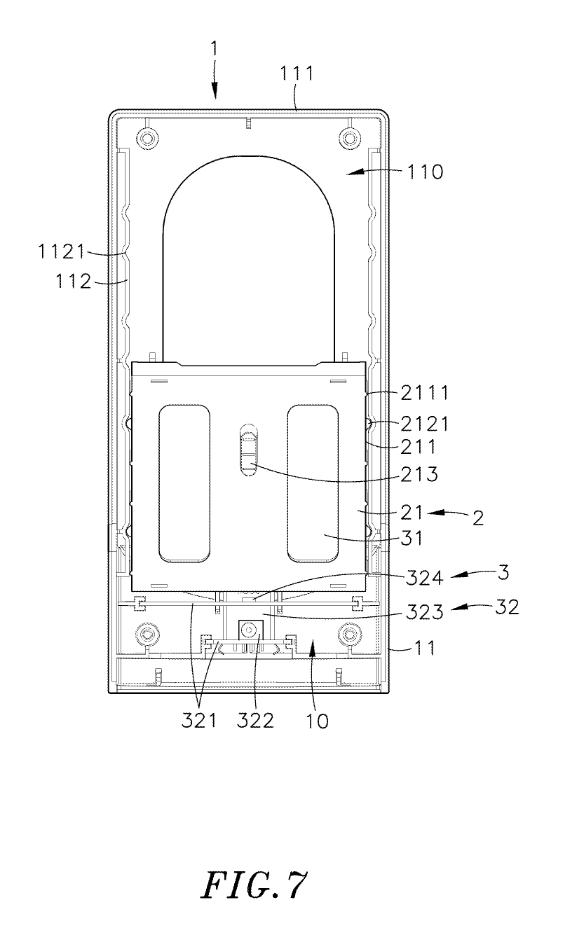

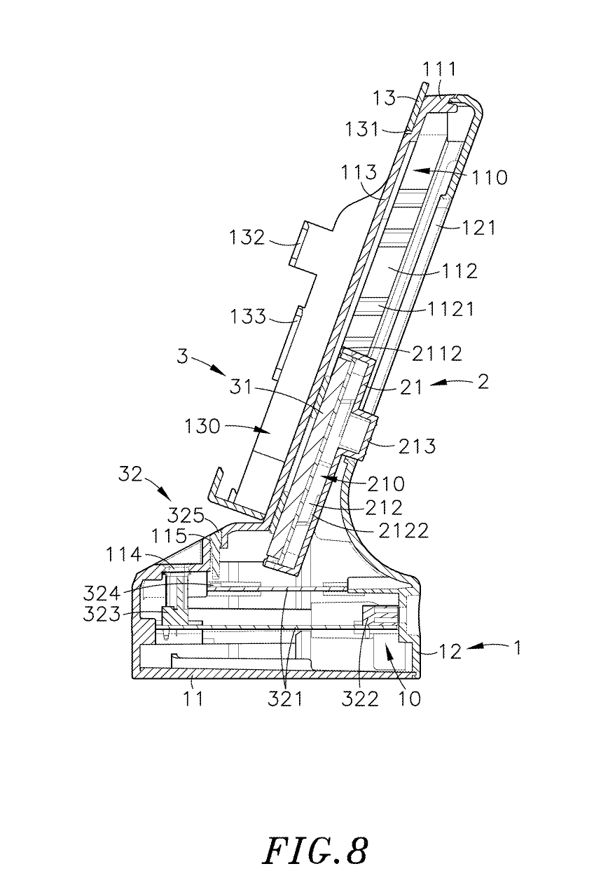

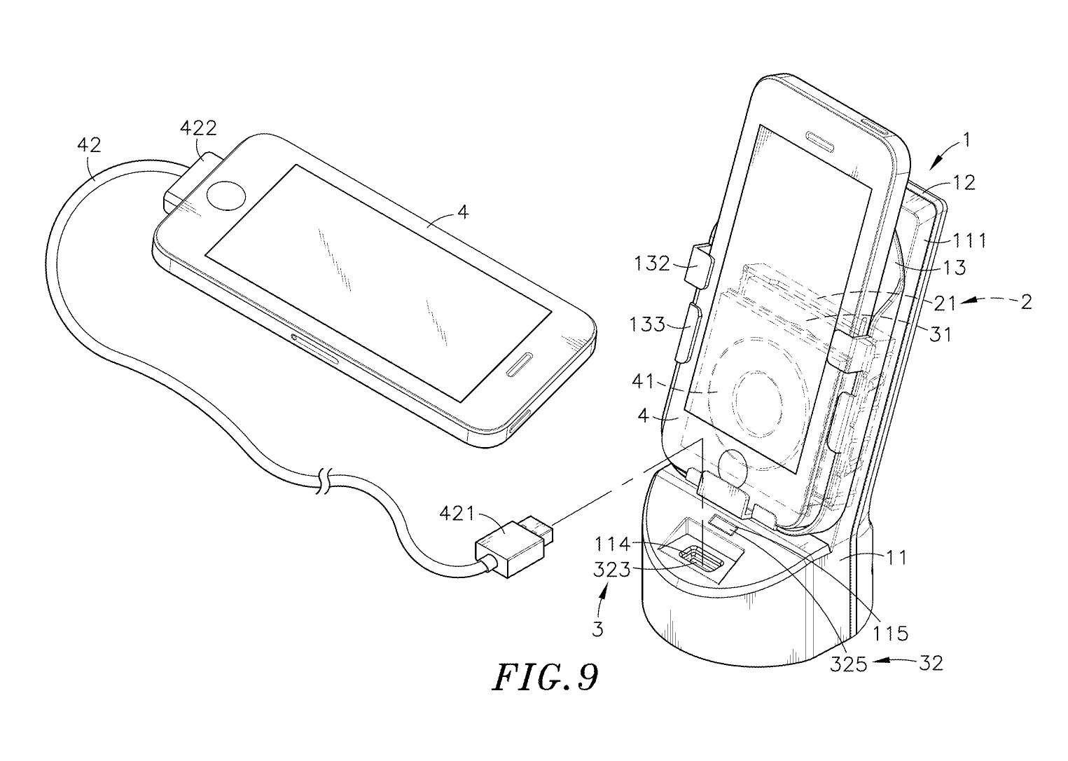

Referring to FIGS. 5-9, the wireless charger of the present invention can be used to charge a mobile electronic device 4. The mobile electronic device 4 comprises a power-receiving coil 41. Further, the mobile electronic device 4 can be a tablet PC, smart phone, PDA, mobile power supply device, etc.

In this application example, the mobile electronic device 4 is downwardly put in the receiving space 130 of the rack 13 and secured in place by the hook lugs 132 that hook on the border area of the top side of the mobile electronic device 4 around the display screen (not shown) thereof, and the locating lugs 133 that clamp the bottom side and periphery of the mobile electronic device 4, avoiding mobile electronic device falling damage and assuring overall structural stability.

When going to adjust the position of the power-supplying coil 31, seize the operating knob 213 at the sliding seat 21 of the push-pull unit 2 with the fingers to move the operating knob 213 along the longitudinal sliding slot 121 of the back cover 12, thereby moving the sliding ways 211 of the sliding seat 21 along the guide rails 112 of the base member 11. During sliding movement of the sliding seat 21, the clamping portions 2121 of the elastic clamping plates 212 will be elastically compressed and released subject to the surface configuration of the guide rails 112 and the position-limit grooves 1121. When the user releases the pressure from the sliding seat 21 after the clamping portions 2121 of the elastic clamping plates 212 reached the selected position-limit grooves 1121, the clamping force exerted by the elastic clamping plates 212 to the selected position-limit grooves 1121 immediately lock the sliding seat 21 to the guide rails 112 of the base member 11.

When moving the sliding seat 21 in the sliding space 110 of the base member 11, the power-supplying coil 31 is moved with the sliding seat 21 along the guide rails 112 to the desired position. After adjustment, the elastic clamping plates 212 lock the sliding seat 21 to the guide rails 112 of the base member 11 in the adjusted position, holding the power-supplying coil 31 in perfect alignment with a power-receiving coil 41 of the mobile electronic device 4.

Further, when adjusting the position of the sliding seat 21, the user's hand can sense a pressure difference upon movement of the clamping portion 2121 of each elastic clamping plate 212 over one position-limit groove 1121, and therefore the sliding seat 21 can be accurately adjusted to the desired position. Further, during sliding movement of the sliding seat 21 along the guide rails 112, the transverse ribs 2111 and raised portions 2112 provide a damping effect to smoothen the sliding motion of the sliding seat 21. Thus, the invention has the characteristics of ease of operation, positioning accuracy, practicability and wide range of applications.

When charging the loaded mobile electronic device 4, the control circuit of the circuit module 32 controls the power-supplying coil 31 to create an alternating electromagnetic field, and the power-receiving coil 41 of the mobile electronic device 4 takes power from the electromagnetic field and converts it back into electrical current to charge the battery of the mobile electronic device 4, i.e., the power-supplying coil 31 and the power-receiving coil 41 in proximity combine to form an electrical transformer, achieving the expected wireless charging.

After the sliding seat 21 is set in position to keep the power-supplying coil 31 of the power supply unit 3 in alignment with the power-receiving coil 41 of the mobile electronic device 4, the circuit module 32 will be triggered to drive the light-emitting device 324 to give off light, enabling the emitted light to be guided by the prism light guide 325 to go through the second through hole 115 of the base member 11 to the outside of the base member 11. During a charging process, the control circuit of the circuit module 32 controls the light-emitting device 324 to emit a different color of light (for example, orange light, green light, blue light or red light) for charging indication, and the power indicator light (not shown) of the mobile electronic device 4 will also be controlled to give off light, providing a visual indication signal.

In another application example, a transmission cable 42 is used to electrically connect the mobile electronic device 4 to the circuit module 32 of the power supply unit 3 of the wireless charger. The transmission cable 42 comprises a first mating electrical connector 421 (for example, male USB connector) located at its one end and electrically connected to the second electrical connector 323 (for example, female USB connector) of the circuit module 32, and a second mating electrical connector 422 (for example, male USB connector) located at its other end and electrically connected to an electrical connector (for example, female USB connector) at the mobile electronic device 4.

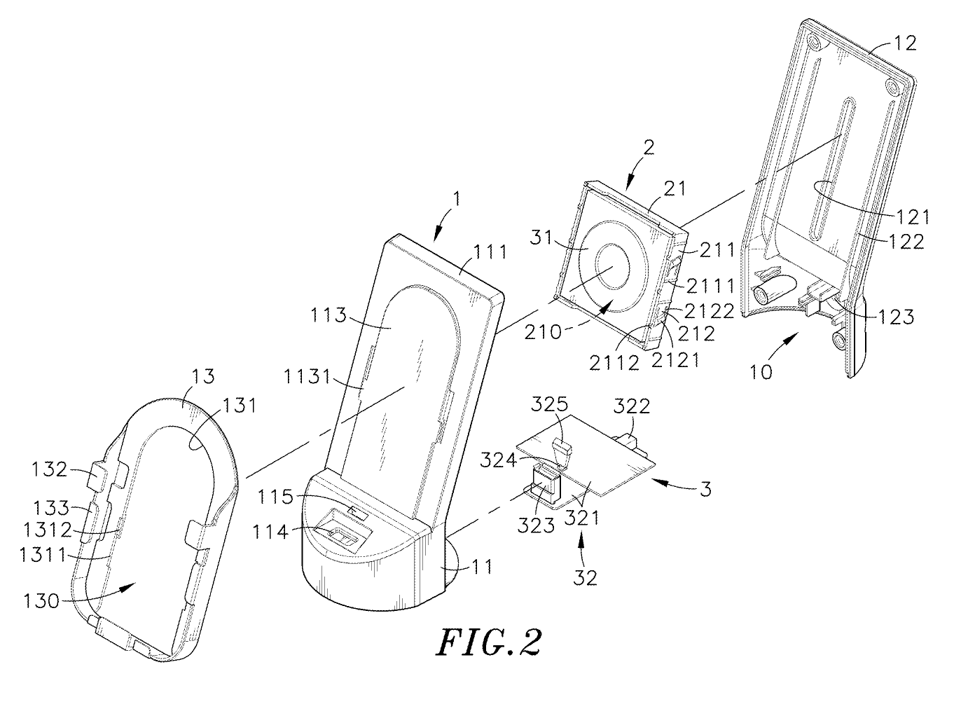

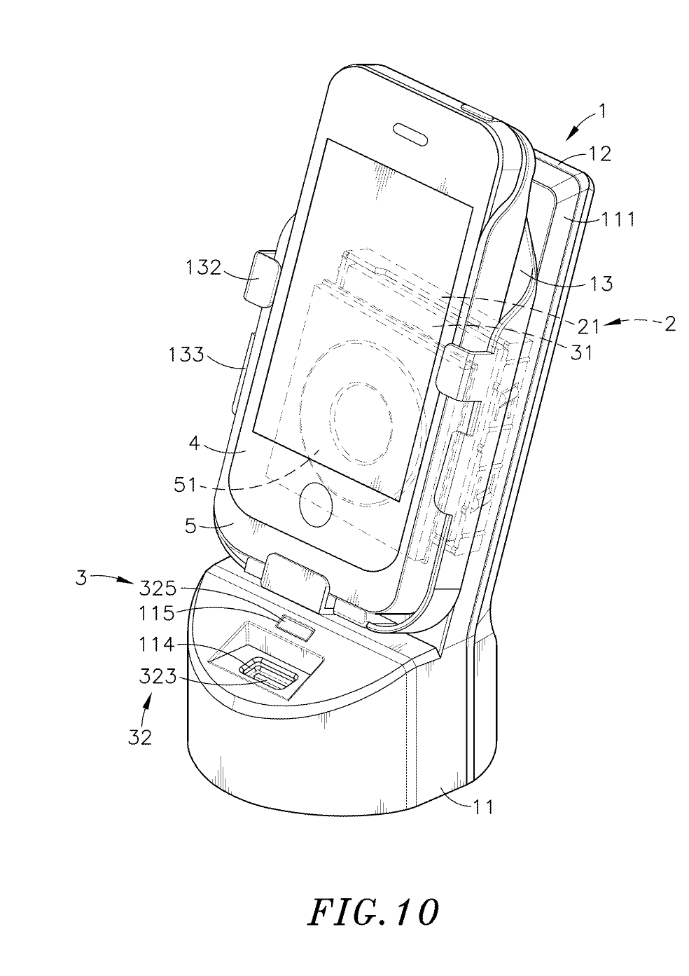

Referring to FIG. 10 and FIGS. 2-4 again, in still another application example of the present invention, the mobile electronic device 4 is provided with a protective cover 5 that carries a power-receiving module having a power-receiving coil 51. After insertion of the mobile electronic device 4 into the protective cover 5, the mobile electronic device 4 is electrically coupled with the power-receiving module. The mobile electronic device 4 with the protective cover 5 can then be put in the rack 13 of the base unit 1 of the wireless charger of the present invention. At this time, the user can operate the operating knob 213 at the sliding seat 21 of the push-pull unit 2 to adjust the power-supplying coil 31 into alignment with the power-receiving coil 51 for induction, enabling the power-receiving coil 51 to take power from the electromagnetic field created by the power-supplying coil 31 and to convert it back into electrical current for charging the battery of the mobile electronic device 4.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A wireless charger, comprising:
a base unit defining therein an accommodation chamber, said base unit comprising a base member, said base member defining a sliding space in a back side thereof;
a push-pull unit mounted in said accommodation chamber of said base unit, said push-pull unit comprising a sliding seat accommodated in said sliding space within said accommodation chamber and slidable in said sliding space along a predetermined path, said sliding seat defining a front mounting space in a front side thereof; and
a power supply unit mounted in said accommodation chamber of said base unit, said power supply unit comprising a power-supplying coil mounted in said front mounting space of said sliding seat of said push-pull unit and a circuit module mounted in said base member and electrically connected with said power-supplying coil for controlling said power-supplying coil to create an alternating electromagnetic field for inductive charging.

2. The wireless charger as claimed in claim 1, wherein said base member comprises an extension plate obliquely upwardly extended from a rear top side thereof and surrounding said sliding space, and two guide rails mounted at said extension plate and respectively extended along two opposite lateral sides of said sliding space in a parallel manner; said push-pull unit further comprises two sliding ways respectively located at two opposite lateral sides of said sliding seat and respectively slidably coupled to said guide rails of said base member of said base unit, and an operating knob extended from the center of a back side of said sliding seat and suspending outside said base unit for operation by a user to move said sliding seat along said guide rails.

3. The wireless charger as claimed in claim 2, wherein said base unit further comprises a back cover fixedly fastened to a back side of said base member to surround said accommodation chamber, said back cover comprising a longitudinal sliding slot extending along said sliding path for the passing of said operating knob and for guiding said operating knob to move along said sliding path.

4. The wireless charger as claimed in claim 3, wherein said back cover further comprises a plughole disposed at a bottom side relative to said longitudinal sliding slot; said circuit module of said power supply unit comprises at least one circuit board adapted for controlling said power-supplying coil to create an alternating electromagnetic field for inductive charging, and a first electrical connector electrically mounted at said at least one circuit board and abutted to said plughole.

5. The wireless charger as claimed in claim 2, wherein said base member further comprises a plurality of position-limit grooves transversely formed in said guide rails and spaced along the length of said guide rails; said push-pull unit further comprises a plurality of elastic clamping plates respectively and symmetrically located at the two opposite lateral sides of said sliding seat and respectively spaced along said sliding ways for selectively engaging said position-limit grooves at said guide rails, each said elastic clamping plate having one end thereof formed integral with one end of one respective opening in one respective said sliding way and an opposite end thereof terminating in a clamping portion for engaging one said position-limit groove at one respective said guide rail.

6. The wireless charger as claimed in claim 5, wherein said sliding seat comprises a plurality of transverse ribs respectively located at said sliding ways at opposing top and bottom sides relative to each said elastic clamping plate and respectively slidably stopped against said guide rails of said base member, and a plurality of raised portions respectively spaced along one side of each of said two sliding ways and respectively slidably stopped against said extension plats of said base member.

7. The wireless charger as claimed in claim 2, wherein said base member further comprises a raised platform located at an opposing front side of said extension plate; said base unit further comprises a rack mounted at said raised platform of said base member, said rack defining a receiving space in a front side thereof for holding a mobile electronic device.

8. The wireless charger as claimed in claim 7, wherein said rack comprises a positioning portion fastened to said raised platform of said base member, two insertion holes disposed at two opposite lateral sides relative to said positioning portion, and two retaining lugs respectively disposed adjacent to said insertion holes; said base member further comprises two retaining lugs protruded from a front side of said extension plate at two opposite lateral sides of said raised platform and respectively inserted through said insertion holes of said rack and respectively hooked up with the retaining lugs of said rack.

9. The wireless charger as claimed in claim 7, wherein said rack further comprises a plurality of hook lugs and locating lugs forwardly extended from the border area thereof for holding a mobile electronic device in said receiving space.

10. The wireless charger as claimed in claim 1, wherein said base member further comprises a first through hole located at a top wall thereof below the elevation of said extension plate; said circuit module of said power supply unit comprises at least one circuit board adapted for controlling said power-supplying coil to create an alternating electromagnetic field for inductive charging, and an electrical connector electrically mounted at said at least one circuit board and abutted to said first through hole for the connection of a mating electrical connector of an external mobile electronic device.

11. The wireless charger as claimed in claim 1, wherein said base member further comprises a second through hole located at the top wall thereof; said circuit module further comprises a light-emitting device electrically connected to said at least one circuit board and controllable by said at least one circuit board to emit light, and a prism light guide adapted to guide emitted light from said light-emitting device to said second through hole of said base member.
